(19) United States
(12) Patent Application Publication
(10) Pub. No.: US 2026/0299782 A1
(43) Pub. Date: Oct. 1, 2026

(54) Method for Implementation of Batched I/O Commands

(71) Applicant: Sandisk Technologies, Inc., Milpitas, CA (US)

(72) Inventors: Judah Gamliel HAHN, Ofra (IL); Stephen GOLD, Fort Collins, CO (US); Yoni SHTERNHELL, Tel Aviv (IL); Amir SEGEV, Meiter (IL)

(73) Assignee: Sandisk Technologies, Inc., Milpitas, CA (US)

(21) Appl. No.: 19/560,961

(22) Filed: Mar. 9, 2026

Related U.S. Application Data
(60) Provisional application No. 63/777,172, filed on Mar. 25, 2025.

(51) Int. Cl. G06F 3/06

(52) U.S. Cl. CPC G06F 3/061; G06F 3/0659; G06F 3/0679

(57) ABSTRACT

Defining order between command executions is challenging. A batch command is a way to ensure command execution and completion atomicity. The batch command comprises multiple logical block address (LBA) ranges. The LBA ranges are compared to entries in an overlap table to search for overlaps. If there are overlaps, then the overlaps need to clear before executing the batch command. If there are no overlaps, then virtual commands are created with each separate range of the batch command comprising a virtual command. The virtual commands are then executed. Only once all of the virtual commands are executed is a completion posted to a host device. The individual virtual command completions are not posted to the host device. Batch read commands can process similar to batch write commands with the exception being that batch read commands do not necessitate overlap table interaction.

### CROSS-REFERENCE TO RELATED APPLICATIONS

This application claims benefit of United States Provisional Patent Application Serial Number 63/777,172, filed Mar. 25, 2025, which is herein incorporated by reference.

### BACKGROUND OF THE DISCLOSURE

### Field of the Disclosure

Embodiments of the present disclosure generally relate to improved command processing.

### Description of the Related Art

Nonvolatile memory (NVM) express (NVMe) does not define ordering between commands. Commands may be fetched, processed, and completed in any order, and from any queue. There is a definition of atomicity for writes, in which write commands with a certain set of device-defined criteria for alignment and size are guaranteed to be atomic against each other and against other reads.

There are use cases in which strict ordering between commands is desired. For example, journals and database transactions require consistency. A set of write operations needs to be executed as a group. NVMe does not have native support for strict ordering, and therefore host side check pointing is used. NVMe does support the compare and write fused command, which allows two specific commands to be connected and executed as a batch. However, fused commands are not scalable and are the only example in NVMe of any kind of ordering.

There is another use case where a group of commands needs to complete before another group can be processed. The ordering is not necessarily important, but the host will need a notification on the completion of a set of commands and the host will need to parse individual completions. The group of commands are typically read commands. An example use case would be where a host side processing unit requires certain data in memory in order to begin operation, but the processing unit is outside of the typical I/O path. For example, a graphics processing unit (GPU) may need a set of game assets in memory to render a frame, but the code which processes the assets is on the GPU, not the central processing unit (CPU) that owns the queues and file system where the request originated from. Ordering between commands in a group is not critical in the situation, but the processing unit would need to know when all of the payloads are in memory with minimal latency. The solution is tracking completions on the CPU that monitors the completion queues and corresponding interrupts, which then needs to notify the requesting device.

Regardless, group commands and command order completion is challenging. Therefore, there is a need in the art for improved command processing.

### SUMMARY OF THE DISCLOSURE

Defining order between command executions is challenging. A batch command is a way to ensure command execution and completion atomicity. The batch command comprises multiple logical block address (LBA) ranges. The LBA ranges are compared to entries in an overlap table to search for overlaps. If there are overlaps, then the overlaps need to clear before executing the batch command. If there are no overlaps, then virtual commands are created with each separate range of the batch command comprising a virtual command. The virtual commands are then executed. Only once all of the virtual commands are executed is a completion posted to a host device. The individual virtual command completions are not posted to the host device. Batch read commands can process similar to batch write commands with the exception being that batch read commands do not necessitate overlap table interaction.

In one embodiment, a data storage device comprises: a memory device; and a controller coupled to the memory device, wherein the controller is configured to: determine whether a write command is a batch command; determine whether an overlap exists between one or more ranges of the batch command and a range in an overlap table; add the one or more ranges of the batch command to the overlap table; create virtual commands for the batch command; execute the virtual commands; and post a completion for the batch command to a host device.

In another embodiment, a data storage device comprises: a memory device; and a controller coupled to the memory device, wherein the controller is configured to: begin processing a batch write command; enumerate a logical block address (LBA) range overlap table; determine that there are no overlaps in the overlap table; add ranges for the batch write command to the overlap table; create virtual commands for the batch write command; complete the virtual commands; and sent a completion to a host device for the batch write command.

In another embodiment, a data storage device comprises: means to store data; and a controller coupled to the means to store data, wherein the controller is configured to: fetch a read command; determine that the read command is a batch read command; create virtual read commands for each range of the batch read command; and post a completion to a host device for the batch read command.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration of dataset management range definitions.

FIG. 3 is a schematic illustration of mapping batched ranges to scatter gather lists (SGLs).

FIG. 4 is a schematic illustration of heterogeneous mapping between logical block address (LBA) ranges and SGLs.

FIG. 5 is schematic illustration of command processing according to one embodiment.

FIG. 6 is a schematic illustration of modules in a data storage system according to one embodiment.

FIG. 7 is a flowchart illustrating batch write command processing according to one embodiment.

FIG. 8 is a flowchart illustrating batch write command processing according to another embodiment.

FIG. 9 is a flowchart illustrating batch read command processing according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Defining order between command executions is challenging. A batch command is a way to ensure command execution and completion atomicity. The batch command comprises multiple logical block address (LBA) ranges. The LBA ranges are compared to entries in an overlap table to search for overlaps. If there are overlaps, then the overlaps need to clear before executing the batch command. If there are no overlaps, then virtual commands are created with each separate range of the batch command comprising a virtual command. The virtual commands are then executed. Only once all of the virtual commands are executed is a completion posted to a host device. The individual virtual command completions are not posted to the host device. Batch read commands can process similar to batch write commands with the exception being that batch read commands do not necessitate overlap table interaction.

As noted above, there is no current solution within a storage device. There are many host-side solutions addressing the use cases, but they have overhead and complexity. A device-side solution will be more scalable.

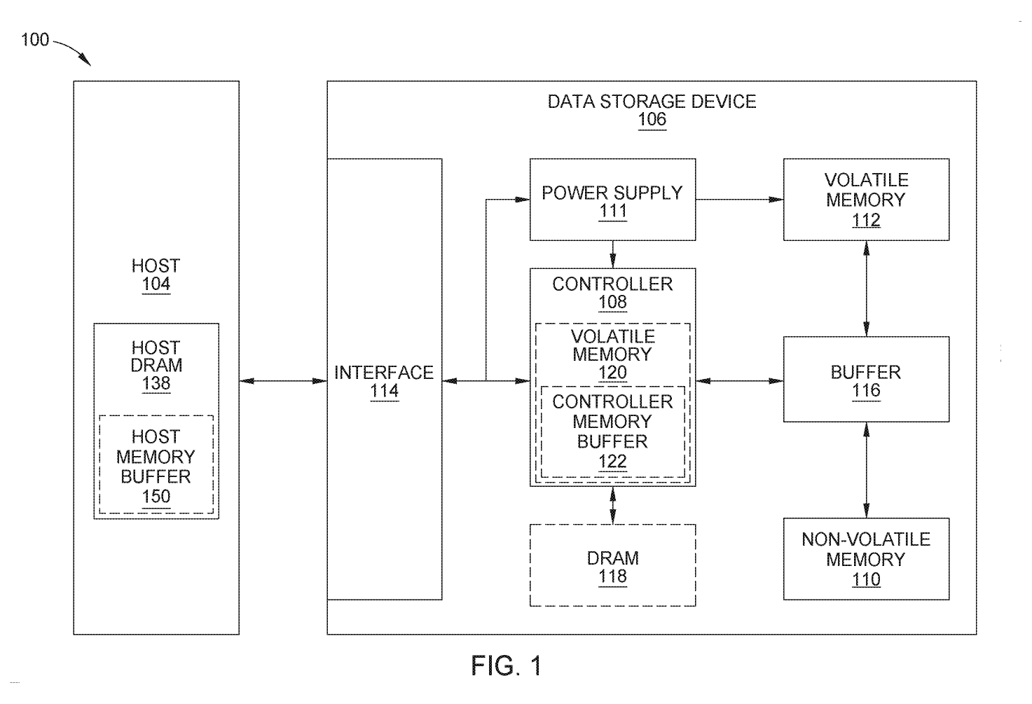

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5” data storage device (e.g., an HDD or SSD), 2.5” data storage device, 1.8” data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128MB, 256MB, 512MB,1GB, 2GB, 4GB, 8GB, 16GB, 32GB, 64GB, 128GB, 256GB, 512GB, 1TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

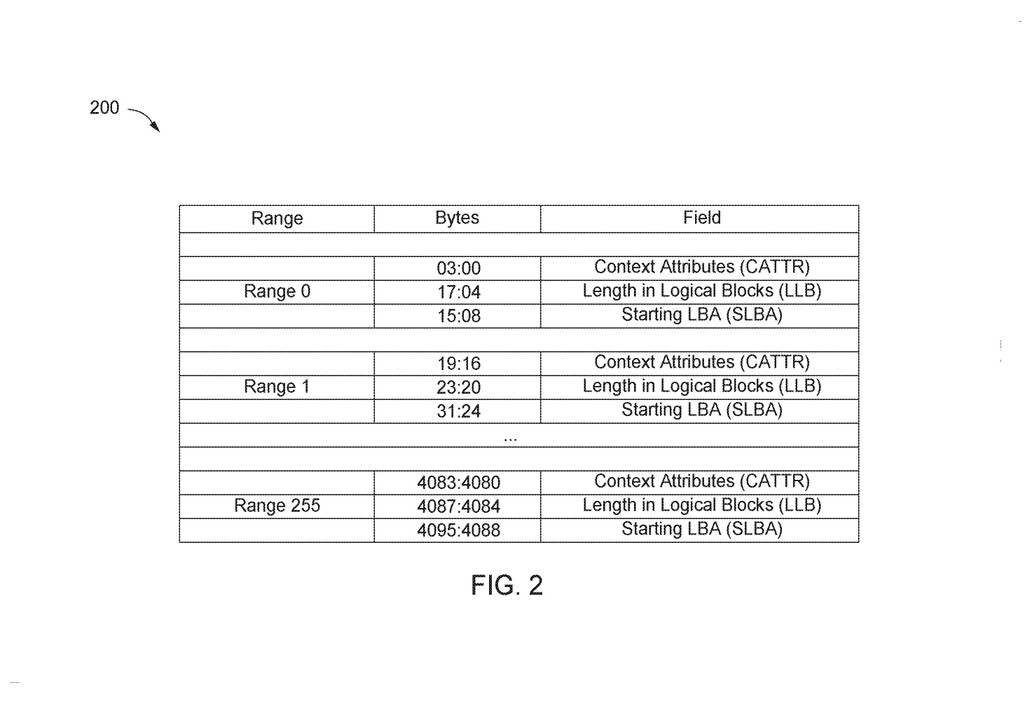

A mechanism for implementing batch input/output (I/O) commands within a solid state drive (SSD), using elements found in current enterprise and client SSD controllers, is discussed herein. The batch I/O commands include a read and write command, each of which can have multiple starting LBAs and corresponding lengths. The semantics of the batch I/O command will be similar to the NVMe dataset management command, which already has a set of range descriptors. FIG. 2 is a schematic illustration 200 of dataset management range definitions for up to 255 ranges. Each of these ranges has a starting LBA and length, similar to existing read and write commands. The batch command will use a list similar to that defined in dataset management with up to 255 LBA ranges, for example, each with a starting LBA (SLBA) and length in logical blocks (LLB) field. The total length of the transfer would be limited to the maximum data transfer size (MDTS) multiplied by the number of ranges or a new limit to be defined. Each range would be limited to the MDTS and have a corresponding (physical region page (PRP) list / scatter-gather list (SGL) or a buffer within the PRP list/SGL. In one embodiment, SGLs would be used because each segment can map precisely to the corresponding SLBA/LLB.

NVMe submission queue (SQ) entries (SQEs) only have two fields that allow memory pointers, data pointer (DPTR) and metadata pointer (MPTR). The DPTR would point to the range table following the convention for other I/O commands that use the same structure. The discussion herein involves passing the SGL/PRP list without breaking convention for DPTR and without complicating the design of a data storage device. The simplest approach is to assign individual SGL/PRP lists within the structure using an additional field which would make it easier to parse and collate commands, but would require multiple memory allocations from the host device. Another approach is to use DPTR to indicate a SGL/PRP list, but define the first 4KB pointed to by the SGL/PRP list to indicate the range table, which would create a bi-directional buffer and the data storage device will need to synchronize accesses to the memory range, but NVMe does not have bi-directional commands.

In commands such as copy and dataset management, the payload is the range table and is indicated by the DPTR. In the batch I/O commands, the range table is only part of the payload. There are a number of ways to combine the range table and the SGL/PRP list ranges.

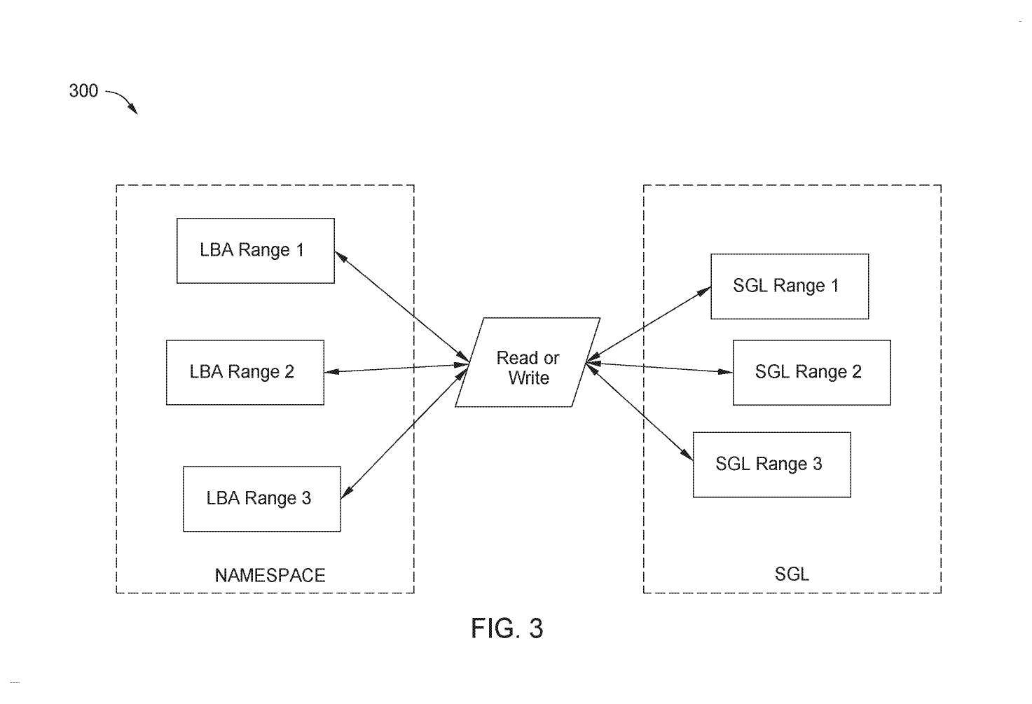

In one example, the range table includes a header which has a pointer to a SGL or a PRP list, shared among all of the ranges. FIG. 3 is a schematic illustration 300 of mapping batched ranges to SGLs where the SGL list is divided between three sets of LBA ranges. FIG. 3 illustrates new read and write commands in which starting LBAs and lengths within the same namespace (NS) can be combined into a single command, mapped against a corresponding set of SGLs/PRPs. The command will complete only when all of the ranges specified within the command are handled.

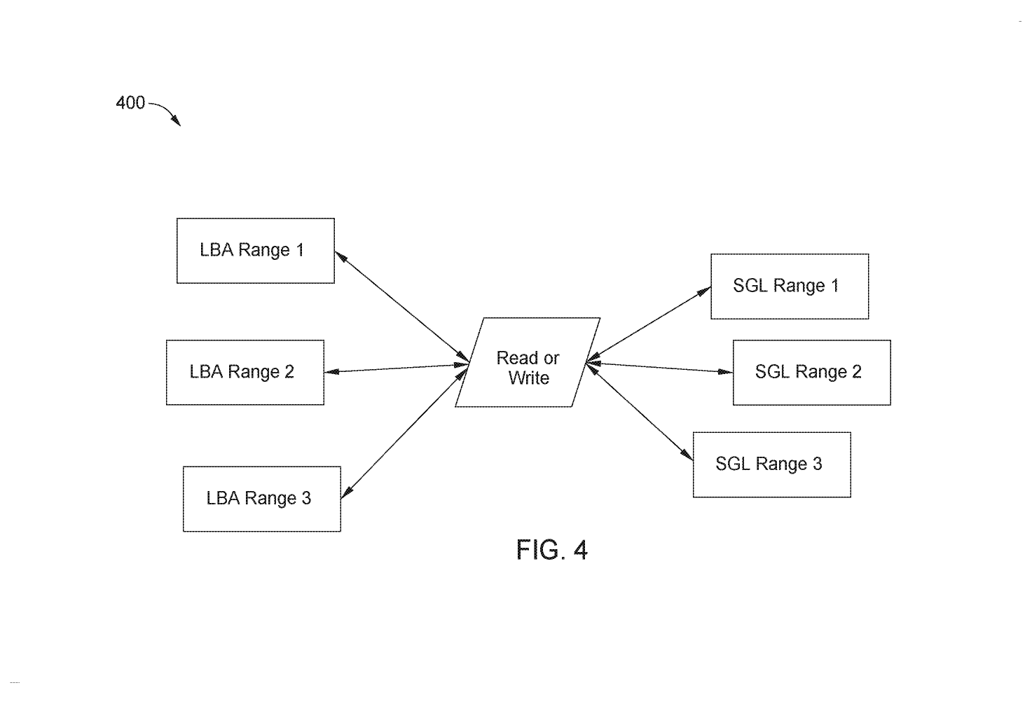

FIG. 4 is a schematic illustration 400 of heterogeneous mapping between LBA ranges and SGLs. In the more complex example shown in FIG. 4, there isn’t a direct correlation between the memory ranges defined in the SGL list and the LBA ranges. PRP lists can also be used. In all cases, the assignment of target memory ranges is based on the order of the LBA ranges. The disclosure herein discusses the implementation of the command in existing storage device architectures, without requiring application specific integrated circuit (ASIC) changes.

SSD controllers typically include hardware (HW) and firmware (FW) in the data paths. Commands which are not automated are passed to FW, which implements logic and may operate the data path. In addition, FW has the capability to generate commands internally and submit the commands. In addition, the controller has an overlap table, which is used to ensure write atomicity. When a LBA range is listed in the overlap table, access to that range by the HW data path will trigger an interrupt to FW, which can either handle the operation, stall the operation, or return the operation to the data path.

When a batch I/O command is submitted by the host device, the batch I/O command is processed by batch I/O processing module on the data storage device. The batch I/O processing module will parse the range table and corresponding PRP/SGLs, and generate new internal commands (i.e., virtual commands or sub commands) for each of the ranges. The new internal commands will be processed as if the new commands were host commands, but the completion will not be reported to the host (i.e., no completion queue (CQ) entry (CQE) is generated). Once all of the internal commands are completed, the module generates a CQE back to the host indicating that the host batch I/O command was completed.

In write commands, there is a need to ensure atomicity against concurrent reads. In addition, there may be multiple batch I/O commands executed in parallel. Therefore, prior to generating the internal commands, the batch I/O processing module scans the overlap table to ensure that all of the LBA ranges specified in the batch write command are not being monitored by an existing write or batch write command. If any of the ranges are already in the overlap table, command processing will wait until the previous command finishes executing and the overlap is cleared from the overlap table.

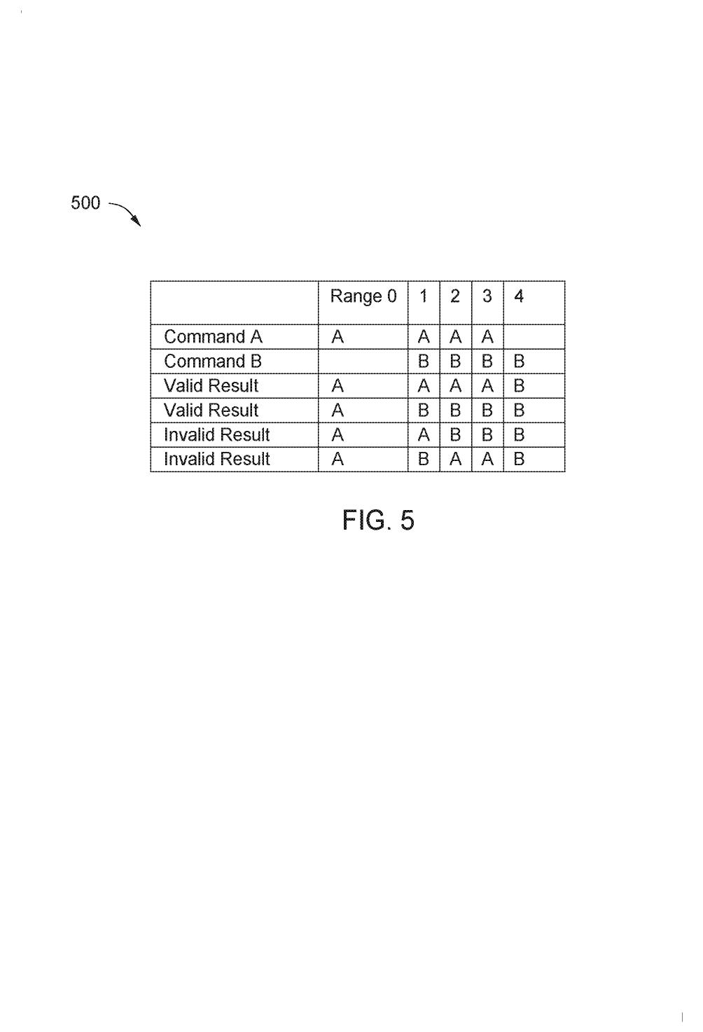

FIG. 5 is schematic illustration 500 of command processing according to one embodiment. A batched write I/O command would need to be atomic across all ranges as long as the command complies with multiple or single atomicity requirements. The entire command would need to be atomic vis-a-vis other reads and writes. A concurrent read should not see data in which ranges from two commands are interspersed. If the host issues batched write commands A and B with overlapping ranges, a concurrent read cannot see mixed results.

In FIG. 5 there is a command A that includes a plurality of different sub commands, and there is another command B that also has several sub commands. The idea is to make sure that, from a batch perspective, the sub commands for command A are all executed as a single unit and all of the sub commands for command B are executed as a single unit. Currently, NVMe does not have an ability to ensure command A completes in a certain order and then command B completes in a certain order. The only real way for a host device to guarantee that command A completes before command B is executed is to wait for the command A to complete and then submit command B.

For executing the commands, the ranges are entered into the overlap table. The ranges are freed atomically (all ranges in the batch are freed at once) just before command completion. For simplicity, it is assumed that the overlap table is protected against multiple conflicting accesses using a synchronization technique, and that the batch I/O commands are not parsed in multiple threads simultaneously. More complex implementations are contemplated.

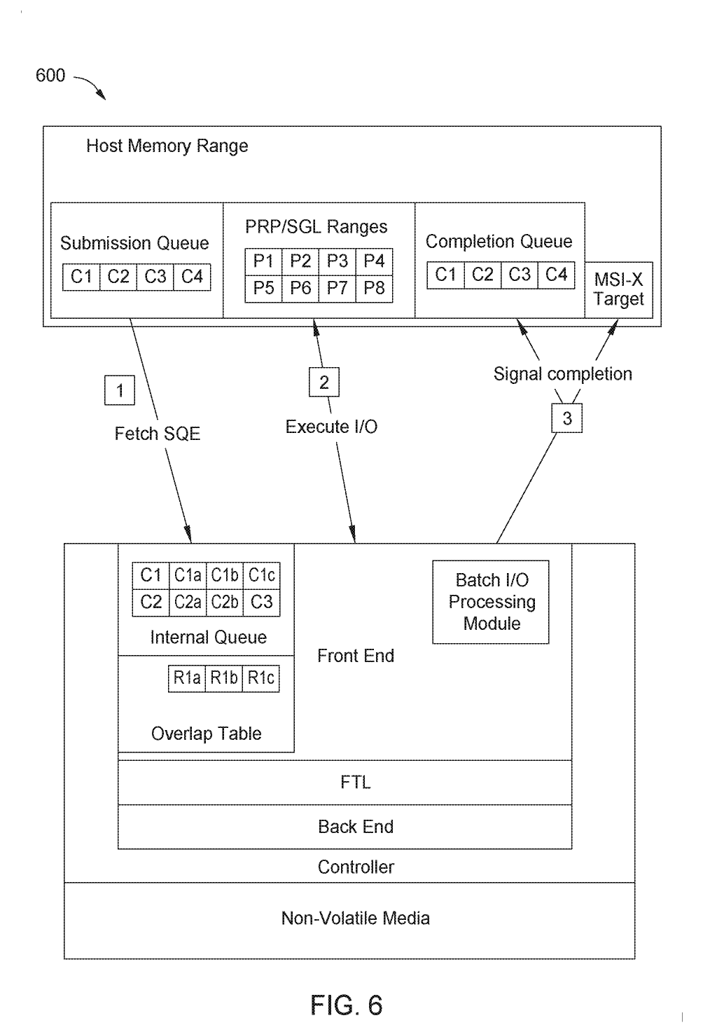

FIG. 6 is a schematic illustration of modules in a data storage system 600 according to one embodiment. FIG. 6 includes a batch I/O processing module in the front end of the data storage device. There is also an internal queue and overlap table in the front end. In operation, commands are going to be submitted to the internal queue. The data storage device has the ability to generate internal commands, and the ability, coupled with the overlap table, ensures atomicity. Write atomicity means that if writing a first batch of commands and a second batch of commands, the batches can't mix and thus the commands complete atomically. So in order to ensure atomicity, there is the overlap table. The overlap table is so that the controller can know to not mix two different commands.

The overlap table will list LBA ranges and if there is a hit, an interrupt occurs. The FW can then decide what to do with the hit. Sometimes the FW’s response will be to handle the overlap anyway, because the overlap table can be recursive. As discussed herein, the controller will take the ranges of a command and corresponding PRPs and SGLs and make new sub commands out of each of the ranges and submit the sub commands internally as if the sub commands are also commands.

The sub commands are not completed back to the host device because the host device does not know the sub commands exist. The sub commands are kept internal. Once the controller knows that all of the sub commands have executed, then a completion for the larger command is provided to the host device.

In FIG. 6 there are four commands shown in the SQ, C1-C4. C1 is a special command that has a plurality of ranges. Therefore, C1 is a batch command. FIG. 6 also shows the CQ with has entries that correspond to the entries in the SQ, not the sub command entries in the internal queue.

In operation, the internal queue pulls C1-C4 and then fills the overlap table. Sub commands are made for C1 and C2 as shown, and the ranges are added to the overlap table. The batch I/O processing module creates the sub commands and populates the overlap table. The commands and sub commands are processed, and completions for the commands C1-C4, not the sub commands, are posted to the CQ.

For a batch write command, the first thing to do is to go to the range table and populate all of the ranges from a command into the overlap table However, before populating the overlap table, the controller has to make sure that the ranges aren't already in the overlap table because if the ranges are already present, then the controller needs to wait for a previous command to complete. The whole point of atomicity is to make sure there isn’t a conflict so if there is an entry already in the overlap table, then the controller waits for the overlap to be cleared.

If there is an overlap, and the overlap clears, the controller adds all the ranges to the overlap table and submits the virtual commands (i.e., sub commands) for each LBA range, assigns the appropriate memory, and then waits for the commands to complete to release the overlap ranges and send the completion to the host device.

For a batch read command, the process is simpler because the controller needs to make sure that if there is an overlap with a write command, then the ranges for the write command need to be in the overlap table. Read commands can overlap, but read commands cannot overlap with write commands. Thus, if there is a write command with a range that overlaps with a read command, then the read command will be held because of the overlaps that are already in place.

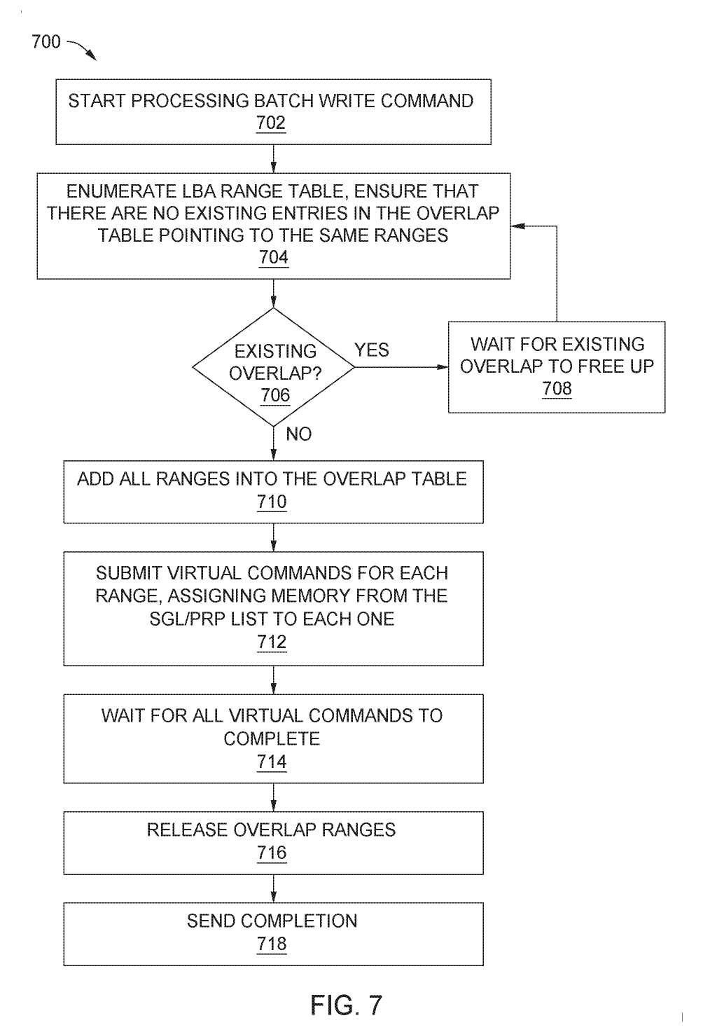

FIG. 7 is a flowchart 700 illustrating batch write command processing according to one embodiment. The flow starts with host command fetching (step 1 in FIG. 6). In this example, commands C1 and C2 are batch write commands, and command C1 has three LBA ranges corresponding to one or more PRP ranges (P1). Command C1 is fetched into the internal command queue, which triggers the batch I/O processing module. The batch I/O processing module executes the flow itself, which begins by scanning the overlap table and checking whether LBA ranges R1a-R1c are already in the table. If the LBA ranges are in the table, the command execution will wait until these ranges are no longer in the table. Following overlap table clearing, the ranges are added to the table, and commands C1a-C1c are created internally. These new commands are then executed using the normal write path. It should be noted that additional handling may be needed to prevent the internal commands from being blocked by the overlap marked by the batch command itself. Once all internal commands complete, the batch command itself is completed back to the host.

Since each batch I/O command is executed independently, each batch I/O command will have a CQE and interrupt. To handle group completion notification to a peer device, batch I/O originating from that peer can be submitted to a separate queue with its own CQ/SQ and MSI-X vector which will guarantee atomicity within each command although will not enforce ordering therebetween. Alternatively, a more complex option is for the batch I/O completion to include new semantics for a separate notification.

More specifically with regards to FIG. 7, the process begins at block 702 where processing of batch write commands begins. The LBA range table is enumerated to ensure that there are no existing entries in the overlap table pointing to the same ranges at block 704. At block 706, a determination is made regarding whether there is an existing overlap. If there is an existing overlap, then the process proceeds to block 708 where the controller waits for existing overlaps to free up followed by a return to block 704. If there is no overlap, then all of the ranges are added to the overlap table at block 710 followed by submitting virtual commands for each range and assigning memory from the SGL/PRP list to each range at block 712. In one embodiment, the SGL/PRP list is individually specified in the range table for each range. In another embodiment, the SGL/PRP list is a shared SGL/PRP list. All of the virtual commands are executed and the controller waits for the virtual commands to complete at block 714. Once all of the virtual commands have completed for a specific command (i.e., once all of the sub commands for C1 have completed), the overlap ranges are released at block 716 followed by sending the completion to the host device at block 718. In one embodiment, the overlap ranges for command C2 are not released due to sub commands for command C2 not yet completing, but the overlap ranges for command C1 are released because the sub commands for command C1 are complete.

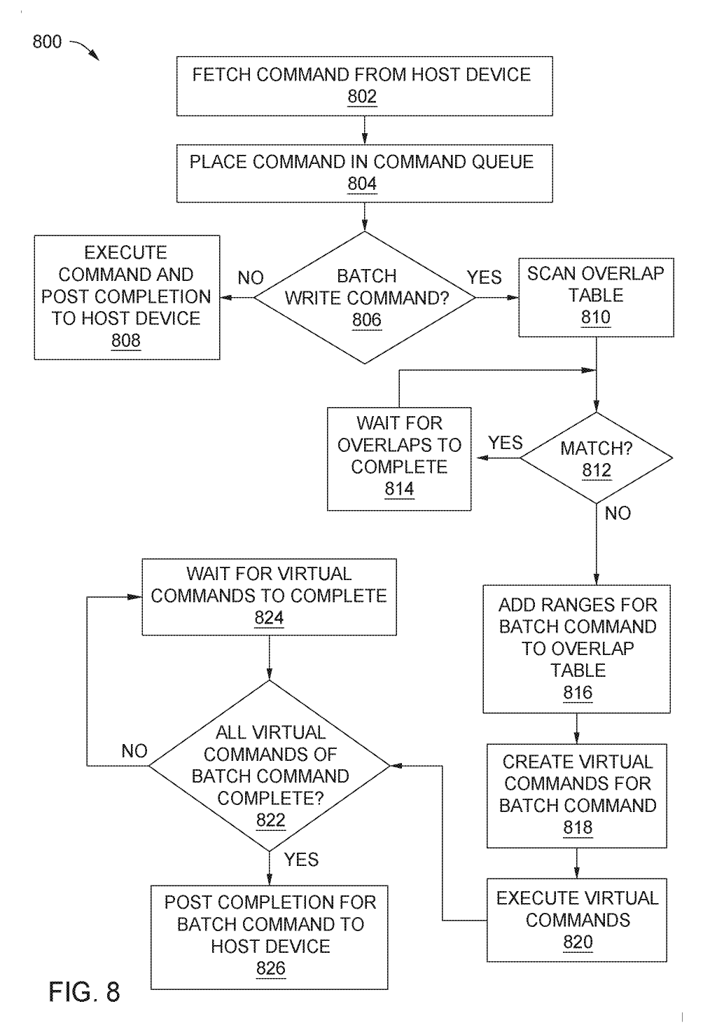

FIG. 8 is a flowchart 800 illustrating batch write command processing according to another embodiment. The process begins at block 802 by fetching a command from the host device. The command is then placed in a command queue at block 804. A determination is made at block 806 regarding whether the command is a batch write command. If the command is not a batch command, then the command is executed in the traditional manner after checking for overlaps followed by posting a completion to the hots device at block 808.

If the command is a batch command, than the overlap table is scanned at block 810 to see if there are any ranges of the batch command that are in the overlap table. If there is a match at block 812, then the controller waits for the overlaps to complete at block 814 and clear the overlap table followed by a return to block 812. If there is no match at block 812, then there is no overlap and the ranges for the batch command are added to the overlap table at block 816. Virtual commands (i.e., sub commands or new commands) are then created for the batch command at block 818 followed by execution of the virtual commands at block 820. A determination is made at block 822 regarding whether all of the virtual commands are complete. If less than all virtual commands are complete, then the controller waits for the virtual commands to complete at block 824 followed by returning to block 822. If all of the virtual commands for a batch command have completed, then a completion is posted to the host device for the batch command at block 826.

It is to be noted that no completion is posted to the host device for any virtual command. It is contemplated that there may be a hidden/virtual CQ where completions are accumulated, but the hidden/virtual CQ would be unknown to the hots device. Furthermore, by all virtual commands completing, it is understood to be all virtual commands for a single batch command. If there are multiple batch commands, there is no need to wait for all virtual commands for all batch commands to complete before sending a completion for a completed batch command. Additionally, it is to be understood that the ranges for virtual commands are removed from the overlap table upon completion of the batch command associated with the virtual commands.

In one implementation, commands C1a-C1c are fetched from an internal SQ/CQ stored in device SRAM, DRAM, or HMB. In another implementation, the commands are generated by the module and do not have a standard completion path.

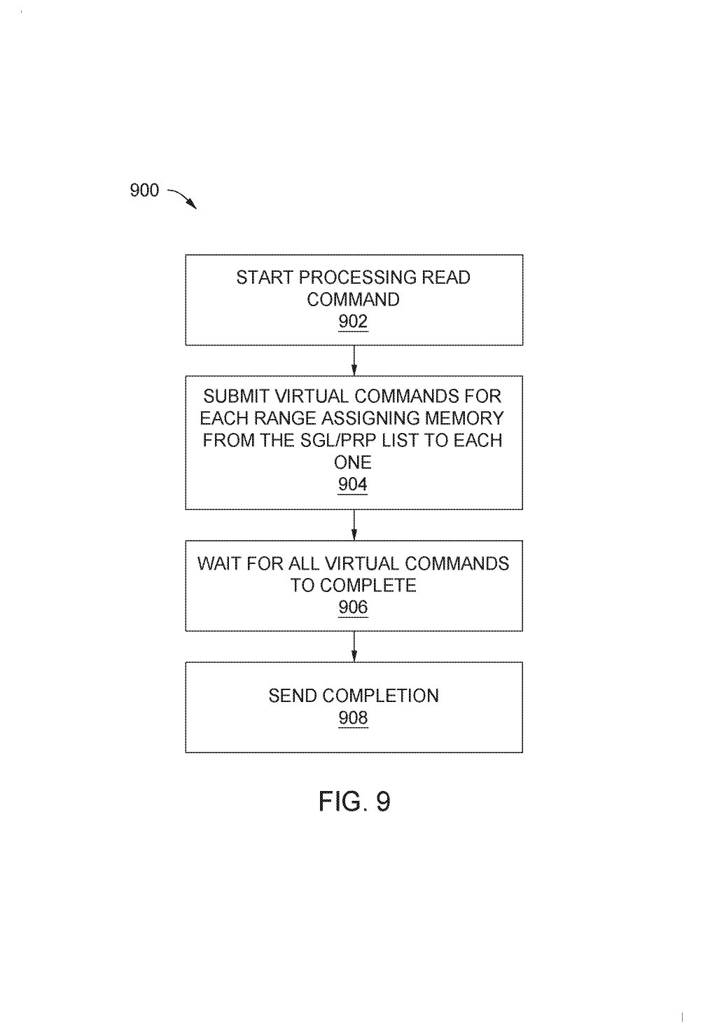

In a read command, the same flow is followed, except that there is no need for explicit overlap table interaction. The internal reads (C2a-C2b in this example) will be automatically synchronized against the pending writes using the overlap detection mechanism already present in the controller. This is shown in FIG. 9. FIG. 9 is a flowchart 900 illustrating batch read command processing according to one embodiment. The process begins by starting processing a read command at block 902 followed by submitting virtual commands for each range assigning memory from SGL/PRP lists to each range at block 904. The controller then waits for all virtual commands to complete at block 906 followed by sending a completion at block 908.

By creating sub commands and using an overlap table, HW changes are avoided and command processing is improved.

In one embodiment, a data storage device comprises: a memory device; and a controller coupled to the memory device, wherein the controller is configured to: determine whether a write command is a batch command; determine whether an overlap exists between one or more ranges of the batch command and a range in an overlap table; add the one or more ranges of the batch command to the overlap table; create virtual commands for the batch command; execute the virtual commands; and post a completion for the batch command to a host device. The controller is configured to perform the adding after determining that an overlap does not exist. The controller is configured to wait to perform the adding until after an existing overlap is cleared from the overlap table. The controller is configured to not post the completion until all virtual commands are complete. The controller comprises a batch input/output (I/O) module. The batch I/O module is configured to scan the overlap table, perform the adding, perform the creating, and perform the executing. The controller is configured to clear the one or more ranges from the overlap table after the executing. The controller is configured to assign memory from a scatter gather list (SGL) / physical region pointer (PRP) list to each virtual command. The controller is configured to: fetch a read command; determine that the read command is a batch read command; create virtual read commands for each range of the batch read command; and post a completion to the host device for the batch read command. The controller is configured to assign memory from a scatter gather list (SGL) / physical region pointer (PRP) list to each virtual read command.

In another embodiment, a data storage device comprises: a memory device; and a controller coupled to the memory device, wherein the controller is configured to: begin processing a batch write command; enumerate a logical block address (LBA) range overlap table; determine that there are no overlaps in the overlap table; add ranges for the batch write command to the overlap table; create virtual commands for the batch write command; complete the virtual commands; and sent a completion to a host device for the batch write command. The controller is configured to release the ranges from the overlap table after completing the virtual commands. The virtual commands are stored in a submission queue (SQ) disposed in the data storage device. The SQ is disposed in static random access memory (SRAM) or dynamic random access memory (DRAM). The virtual commands are generated by a batch input/output (I/O) processing module. The batch I/O processing module does not have a completion path. The controller does not post completions to the host device for the virtual commands.

In another embodiment, a data storage device comprises: means to store data; and a controller coupled to the means to store data, wherein the controller is configured to: fetch a read command; determine that the read command is a batch read command; create virtual read commands for each range of the batch read command; and post a completion to a host device for the batch read command. The controller is configured to: fetch a write command; determine that the write command is a batch write command; create virtual write commands for each range of the batch write command; and post a completion to the host device for the batch write command. The controller does not post completions to the host device for completed virtual read commands or completed virtual write commands.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
determine whether a write command is a batch command;
determine whether an overlap exists between one or more ranges of the batch command and a range in an overlap table;
add the one or more ranges of the batch command to the overlap table;
create virtual commands for the batch command;
execute the virtual commands; and
post a completion for the batch command to a host device.

2. The data storage device of claim 1, wherein the controller is configured to perform the adding after determining that an overlap does not exist.

3. The data storage device of claim 1, wherein the controller is configured to wait to perform the adding until after an existing overlap is cleared from the overlap table.

4. The data storage device of claim 1, wherein the controller is configured to not post the completion until all virtual commands are complete.

5. The data storage device of claim 1, wherein the controller comprises a batch input/output (I/O) module.

6. The data storage device of claim 5, wherein the batch I/O module is configured to scan the overlap table, perform the adding, perform the creating, and perform the executing.

7. The data storage device of claim 1, wherein the controller is configured to clear the one or more ranges from the overlap table after the executing.

8. The data storage device of claim 1, wherein the controller is configured to assign memory from a scatter gather list (SGL) / physical region pointer (PRP) list to each virtual command.

9. The data storage device of claim 1, wherein the controller is configured to:
fetch a read command;
determine that the read command is a batch read command;
create virtual read commands for each range of the batch read command; and
post a completion to the host device for the batch read command.

10. The data storage device of claim 9, wherein the controller is configured to assign memory from a scatter gather list (SGL) / physical region pointer (PRP) list to each virtual read command.

11. A data storage device, comprising:
a memory device; and
a controller coupled to the memory device, wherein the controller is configured to:
begin processing a batch write command;
enumerate a logical block address (LBA) range overlap table;
determine that there are no overlaps in the overlap table;
add ranges for the batch write command to the overlap table;
create virtual commands for the batch write command;
complete the virtual commands; and
sent a completion to a host device for the batch write command.

12. The data storage device of claim 11, wherein the controller is configured to release the ranges from the overlap table after completing the virtual commands.

13. The data storage device of claim 11, wherein the virtual commands are stored in a submission queue (SQ) disposed in the data storage device.

14. The data storage device of claim 13, wherein the SQ is disposed in static random access memory (SRAM) or dynamic random access memory (DRAM).

15. The data storage device of claim 11, wherein the virtual commands are generated by a batch input/output (I/O) processing module.

16. The data storage device of claim 15, wherein the batch I/O processing module does not have a completion path.

17. The data storage device of claim 11, wherein the controller does not post completions to the host device for the virtual commands.

18. A data storage device, comprising:
means to store data; and
a controller coupled to the means to store data, wherein the controller is configured to:
fetch a read command;
determine that the read command is a batch read command;
create virtual read commands for each range of the batch read command; and
post a completion to a host device for the batch read command.

19. The data storage device of claim 18, wherein the controller is configured to:
fetch a write command;
determine that the write command is a batch write command;
create virtual write commands for each range of the batch write command; and
post a completion to the host device for the batch write command.

20. The data storage device of claim 18, wherein the controller does not post completions to the host device for completed virtual read commands or completed virtual write commands.
